(19) United States
(12) Patent Application Publication
(10) Pub. No.: US 2014/0322464 A1
(43) Pub. Date: Oct. 30, 2014

(54) ACTIVATABLE MATERIAL AND CARRIER ATTACHMENT

(71) Applicant: Zephyros, Inc., Romeo, MI (US)

(72) Inventors: Kevin Renno, Port Huron, MI (US); Craig Langevin, Troy, MI (US); Todd Deachin, Goodrich, MI (US)

(73) Assignee: Zephyros, Inc., Romeo, MI (US)

(21) Appl. No.: 14/261,588

(22) Filed: Apr. 25, 2014

Related U.S. Application Data
(60) Provisional application No. 61/816,220, filed on Apr. 26, 2013.

(51) Int. Cl. B29C 45/14

(52) U.S. Cl. CPC B29C 45/1418
USPC 428/35.7; 264/266

(57) ABSTRACT

A method for making an activatable insert, comprising the steps of locating a carrier having at least one hollow columnar projection in an overmolding tool the at least one hollow columnar projection having an intermediate portion and a free end portion, wherein the intermediate portion and the free end portion each have generally the same perimeter dimension; deforming the at least one hollow columnar projection while it is within the overmolding tool to form a permanently deformed projection such that the free end portion of the permanently deformed projection has a perimeter dimension that exceeds the perimeter dimension of the intermediate portion; and overmolding an activatable material onto the carrier so that the activatable material substantially surrounds the deformed projection, and the deformed projection helps to retain the activatable material on the carrier.

### TECHNICAL FIELD

The present invention pertains generally to activatable inserts for filling an automotive vehicle cavity, and more particularly to activatable inserts that employ an improved in situ formed mechanical interlock connection between a carrier and a material that is activatable for expansion.

### BACKGROUND

In the automotive vehicle field there are a number of applications in which an activatable material is attached to a carrier. The activatable material may be activated by heat, moisture, radiation or some other stimulus to cause it to flow, seal, expand or otherwise change state while in a vehicle cavity. A carrier is commonly employed for supporting the activatable material, and for securing the part within a vehicle cavity. For example, one or more clips may project from the carrier for clipping the part into an opening in vehicle sheet metal.

Particularly if an application seeks to avoid the additional processing step of heat bonding of activatable material to the carrier, there are a number of alternative ways for attaching such activatable materials to a carrier. Examples include the use of solid molded posts, mushroom caps of activatable material that penetrate though an aperture, or even mechanical fasteners (e.g., a staple). Notwithstanding these approaches, there remains a need for yet additional alternatives. Attractive alternatives include those alternatives by which secondary operations for attaching the activatable material can be avoided after overmolding.

### SUMMARY OF THE INVENTION

The teachings herein contemplate a method for making an activatable insert, comprising the steps of locating a carrier having at least one hollow columnar projection in an overmolding tool, the at least one hollow columnar projection having an intermediate portion and a free end portion, wherein the intermediate portion and the free end portion each have generally the same perimeter dimension; deforming the at least one hollow columnar projection while it is within the overmolding tool to form a permanently deformed projection such that the free end portion of the permanently deformed projection has a perimeter dimension that exceeds the perimeter dimension of the intermediate portion; and overmolding an activatable material onto the carrier so that the activatable material substantially surrounds the deformed projection, and the deformed projection (e.g., due to a flared shape) helps to retain the activatable material on the carrier.

The teachings herein also contemplate an activatable insert for insertion in a cavity of an automotive vehicle, comprising: a polymeric carrier having at least one deformed hollow columnar projection that has a free end and an end that is proximal a base wall of the carrier, the free end having an outer perimeter dimension that is enlarged relative to an outer perimeter dimension at an intermediate location along the projection; an activatable material overmolded onto the polymeric carrier and being held on the polymeric carrier by the at least one deformed hollow columnar projection.

The teachings herein provide for a simplified method of securely attaching a material layer (e.g., an activatable material) to a carrier, whereby the attachment process takes place simultaneously during molding of the material layer onto the carrier such that no additional processing steps are necessary.

### DESCRIPTION OF THE DRAWINGS

FIG. 1 illustrates an example of a section of a carrier according to the present teachings before overmolding.

FIG. 2 illustrates an example of the section of FIG. 1 after overmolding.

FIG. 3a is a view of one side of an article in accordance with the present teachings.

FIG. 3b is a view of an opposite side of the article of FIG. 3a.

FIG. 4 is an enlarged view of a portion of FIG. 3a.

FIG. 5 is a perspective view of an illustrative part made with the attachment of the present teachings, including an activatable material on a carrier, and attachment devices on a side edge.

FIG. 6 is a side profile view of the part shown at FIG. 5.

### DETAILED DESCRIPTION

This application claims the benefit of the filing date of U.S. Provisional Application Ser. No. 61/816,220 filed Apr. 25, 2013, the contents of such application being hereby incorporated by reference for all purposes.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein make advantageous use of a simple, but elegant solution to difficulties faced when having to join activatable materials (e.g., any secondary material layer) with a carrier. Activatable materials herein are typically polymeric materials that upon being subjected to a stimulus (e.g., heat, moisture, radiation, or any combination thereof) will flow, seal, expand and/or otherwise change state. Typically, such stimulus arises upon being subjected to heat from a paint bake operation in automotive paint shop. It is common for such materials, upon exposure to heat, to expand and fill a cavity. It is common to employ carriers that support the activatable material. In some instances, it is possible that the activatable material will heat bond to the carrier. But, this may be impractical in some instances. Thus, in accordance with the teachings herein, there is disclosed a unique, simple yet elegant solution for securing activatable material to a carrier.

The carrier may be formed by an injection molding process. The carrier may be formed by an extrusion process. The projections referred to herein for attaching the activatable material to the carrier may be integrally formed with the carrier during formation of the carrier. Alternatively, the projections may be located onto the carrier via a secondary connecting process (such that the projections are not integrally formed with the carrier). The projections may be formed having any shape or profile. In one embodiment, the projections are columnar in shape. The projections may be formed in any shape that allows for easy deformation of the projection during an overmolding process. Such deformation may form a projection having a free end having a larger perimeter than any other adjacent portion of the projection such that the expanded free end acts to maintain any material overmolded onto the carrier below the free end (or at least not extending beyond a terminating edge of the projection. As a result, the deformed free end (or at least a portion thereof) may be visible even after overmolding a material layer onto the carrier. However, upon activation of the material layer, the visible end of the projection may no longer be visible.

Deformation of the projection during the overmolding process simplifies part production and processing in that additional processing steps or fastening mechanisms are no longer required for attaching a secondary (e.g., activatable) material to the carrier. This results in a substantial reduction in cycle time for the part and may also result in reduced material usage.

The activatable material may be a polymeric material that is activated to flow, seal, expand or any combination thereof. It may be a material that forms a foam (e.g., an acoustic foam or a structural foam). It may expand from its original volume to at least 150%, 300%, 500%, or even 1000% or larger of its original volume.

The activatable material may be activated when subjected to heat during paint shop baking operations. In applications where the activatable material is a heat activated, thermally expanding material, an important consideration involved with the selection and formulation of the material comprising the activatable material is the temperature at which a material reaction or expansion, and possibly curing, will take place. For instance, in most applications, it is undesirable for the material to be reactive at room temperature or otherwise at the ambient temperature in a production line environment. More typically, the activatable material becomes reactive at higher processing temperatures, such as those encountered in an automobile assembly plant, when the material is processed along with the automobile components at elevated temperatures or at higher applied energy levels, e.g., during paint or e-coat curing or baking steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. One or more sides of the activatable material may be tacky. One or more sides of the activatable material may be generally tack free to the touch at room temperature. Following activation of the activatable material, the material will typically cure. Thus, it may be possible that the activatable material may be heated, it may then expand, and may thereafter cure to form a resulting foamed material.

The carrier may be any suitable material. Desirably it will have a melting point or glass transition temperature that is higher than that of the activatable material. In this way, the carrier will generally retain its as-molded shape during overmolding (with the exception of the free end of the column projection). An example of a material is a polyamide, such as Nylon 66. The carrier may include other features, such as a clip for mounting the carrier within a cavity of an automotive vehicle.

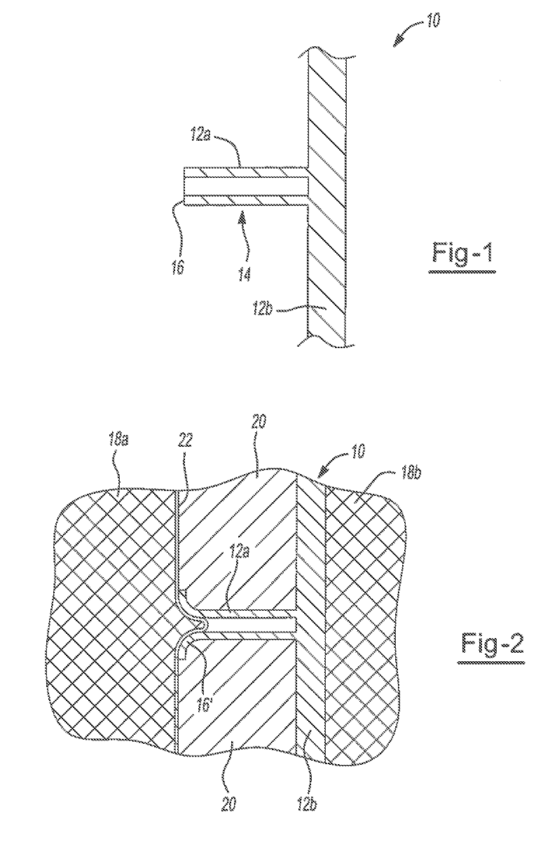

To show specific examples of the methods and inserts discussed herein, with reference to FIG. 1, there is seen a section of a carrier 10 (e.g., a molded polymeric carrier, such as a molded polyamide carrier) that includes at least one projection 12a that projects from a base 12b. The projection has an intermediate portion 14 and a free end 16. The projection may be a hollow column for at least a portion of its height. Prior to any overmolding, the outer peripheral dimension of the intermediate portion 14 is generally the same as that of the free end 16. As seen in FIG. 2, during overmolding, it is envisioned that a tool portion 18a will apply sufficient force to the free end to permanently deform the free end so that it has an outer peripheral dimension that is larger than that of the intermediate portion. In this manner, a lip 16′ is effectively formed at the free end that can be employed for mechanically retaining the activatable material 20 on the carrier 10. For instance, when the carrier 10 placed between tool portions 18a and 18b, the tool portion 18a causes the end 16 to permanently flare out or mushroom. The structure that causes attachment of the activatable material 20 to the carrier 10 is thus formed in situ when the tool portions 18a and 18b are brought together during an overmolding step (e.g., when the molding press is closed). The resulting height of the projection 12a is approximately the thickness of the activatable material 20. The resulting peripheral dimension of the flared end 16′ may be at least 5%, 10%, 20%, 50% or larger than its original state. The outermost portion of the flared end 16′ may be generally co-planar with or above an upper surface 22 of the activatable material.

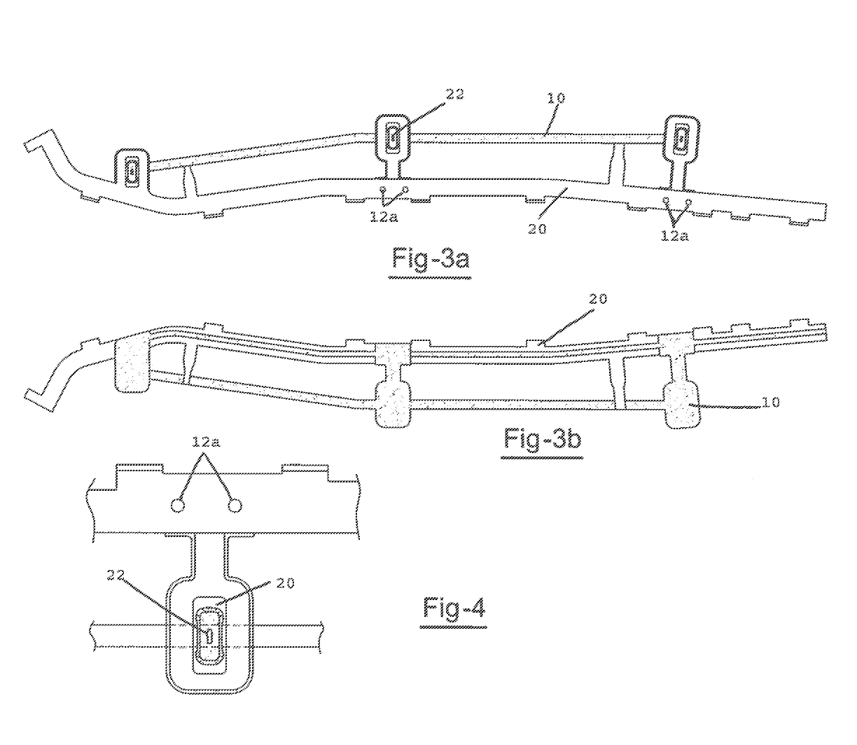

FIGS. 3a and 3b illustrate an article made in accordance with the present teachings. As seen an elongated carrier 10 supports an activatable material 20. In the embodiment shown, activatable material encircles clips 22 formed integrally with the carrier. Further, multiple projections 12a are shown. Both the clips 22 and projections 12a are substantially surrounded by the activatable material 20. This is shown particularly in FIG. 4, which also depicts multiple distinct attachment features of the present teachings. Projections 12a attach activatable material 20 to the carrier 10. A clip 22 may be surrounded by activatable material 20. Such activatable material may remain in place mechanically, e.g. in the absence of an adhesive bond between the carrier and the activatable material,

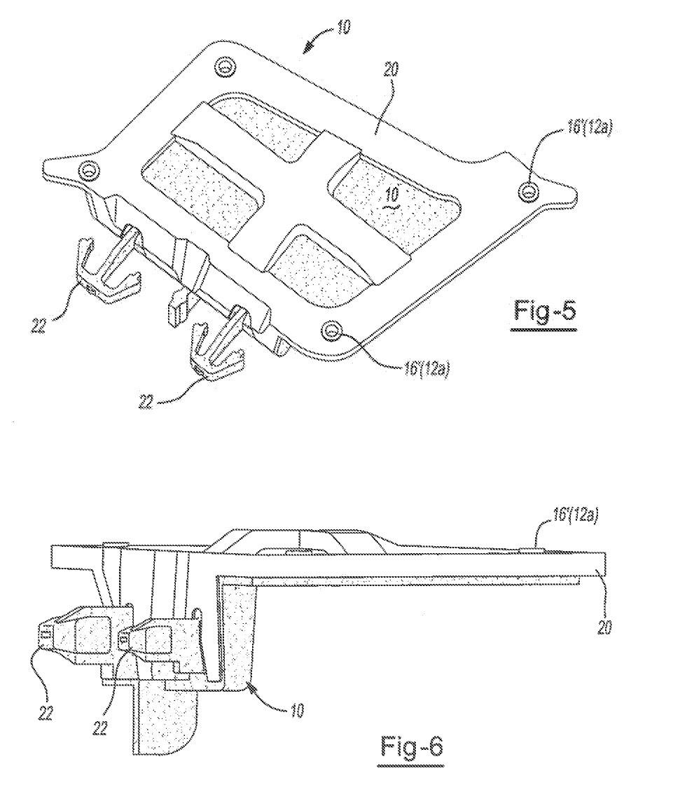

FIGS. 5 and 6 depict additional parts including the columnar projections 12a for attaching the activatable material 20 to the carrier 10. The projections are shown having a free-end 16′ that flares out or “mushrooms” to cause attachment of the expandable material to the carrier. The parts include clips 22 that project outwardly generally in a plane that lies below a planar portion of the carrier.

The methods herein may be free of any secondary operation of tooling, subsequent to overmolding, for causing the at least one hollow columnar projection to help retain the activatable material on the carrier. The overmolding may be performed as part of a rotary injection molding operation. Further, the activatable material is retained on the carrier in the substantial absence of any heat bonding of the activatable material to the carrier. The activatable material may be retained on the carrier in the substantial absence of any secondary fastener for bonding the activatable material to the carrier. The method may include activating the activatable material. The free end of the projections may be visible after overmolding the activatable material onto the carrier but prior to any activation of the activatable material. The method may be used to form an insert that may include at least one connecting element for mechanically interlocking an aperture in sheet metal of an automotive vehicle. The insert may be free of any secondary fastener for connecting the activatable material to the carrier. The insert may include projections having a free end which may or may not be visible after overmolding the activatable material onto the carrier. The free end of a projection may not be visible after activation of the activatable material.

The teachings herein afford a way to retain activatable material on a carrier, and is especially suitable for many instances when attachment is not otherwise attainable. The techniques herein may be used in transfer molding processes. The techniques herein may be used in insert molding processes.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method for making an activatable insert, comprising the steps of:
a. locating a carrier having at least one hollow columnar projection in an overmolding tool the at least one hollow columnar projection having an intermediate portion and a free end portion, wherein the intermediate portion and the free end portion each have generally the same perimeter dimension;
b. deforming the at least one hollow columnar projection while it is within the overmolding tool to form a permanently deformed projection such that the free end portion of the permanently deformed projection has a perimeter dimension that exceeds the perimeter dimension of the intermediate portion;
c. overmolding an activatable material onto the carrier so that the activatable material substantially surrounds the deformed projection, and the deformed projection helps to retain the activatable material on the carrier.

2. The method of claim 1, wherein the step of locating includes injection molding the carver having the at least one hollow columnar projection.

3. The method of claim 1, wherein the method is free of any secondary operation of tooling, subsequent to overmolding, for causing the at least one hollow columnar projection to help retain the activatable material on the carrier.

4. The method of claim wherein the overmolding is performed as part of a rotary injection molding operation.

5. The method of claim 1, wherein the activatable material is retained on the carrier in the substantial absence of any heat bonding of the activatable material to the carrier.

6. The method of claim 1, wherein the activatable material is retained on the carrier in the substantial absence of any secondary fastener for bonding the activatable material to the carrier.

7. The method of claim 1, including integrally forming the columnar projection with the carrier.

8. The method of claim 1, wherein the step of locating includes extruding the carrier having the at least one columnar projection.

9. The method of claim 1, including activating the activatable material.

10. The method of claim 1, wherein the free end is visible after overmolding the activatable material onto the carrier but prior to any activation of the activatable material.

11. An activatable insert for insertion in a cavity of an automotive vehicle, comprising:
a. a polymeric carrier having at least one deformed hollow columnar projection that has a free end and an end that is proximal a base wall of the carrier, the free end having an outer perimeter dimension that is enlarged relative to an outer perimeter dimension at an intermediate location along the projection;
b. an activatable material overmolded onto the polymeric carrier and being held on the polymeric carrier by the at least one deformed hollow columnar projection.

12. The activatable insert of claim 11, wherein the insert includes at least one connecting element for mechanically interlocking an aperture in sheet metal of an automotive vehicle.

13. The activatable insert of claim 11, wherein the insert is free of any secondary fastener for connecting the activatable material to the carrier.

14. The activatable insert of claim 11, wherein the free end is visible after overmolding the activatable material onto the carrier.

15. The activatable insert of claim 11, wherein the free end is not visible after overmolding the activatable material onto the carrier.

16. The activatable insert of claim 11, wherein the free end is not visible after activation of the activatable material.

17. The activatable insert of claim 11, wherein the columnar projection is integrally formed with the carrier.

18. The activatable insert of claim 11, wherein the activatable material is overmolded onto the carrier as part of a rotary injection molding operation.

19. The activatable insert of claim 11, wherein the carrier is injection molded or extruded.

20. The activatable insert of claim 11, wherein the activatable material is retained on the carrier in the substantial absence of any heat bonding of the activatable material to the carrier.
